(19) United States
(12) Patent Application Publication
(10) Pub. No.: US 2017/0138250 A1
(43) Pub. Date: May 18, 2017

(54) APPARATUS FOR REPLACING COOLANT FOR VEHICLE

(71) Applicant: CHUAN JIING ENTERPRISE CO.,LTD., Taichung (TW)

(72) Inventor: TIEN-TSAI TSENG, Taichung City (TW)

(21) Appl. No.: 14/944,063

(22) Filed: Nov. 17, 2015

(51) Int. Cl. F01P 11/02; B67D 7/38; B67D 7/02

(52) U.S. Cl. CPC F01P 11/0276; B67D 7/0205; B67D 7/0288; B67D 7/38

(57) ABSTRACT

An apparatus for replacing coolant includes a communication unit, a pressure gauge, a flexible tube, a conical plug, a valve and a vacuum producer. The communication unit includes a first port, a second port and a third port in communication with one another. The pressure gauge is connected to the third port. The flexible tube is connected to the first port. The conical plug includes a liquid channel extending throughout the conical plug. The liquid channel is connected to the flexible tube. The valve includes a switch and a pneumatic quick coupling device. The switch is connected to the second port to selectively allow or stop communication of the pneumatic quick coupling device with the second port. The vacuum producer includes a pump and a hollow insert extending from the pump. The hollow insert is adapted for connection to the pneumatic quick coupling device so that the pump is operable to produce vacuum in the valve.

### BACKGROUND OF INVENTION

1. Field of Invention

The present invention relates to coolant of a vehicle and, more particularly, to an apparatus for replacing coolant for a vehicle.

2. Related Prior Art

A vehicle includes an engine, a gearbox and a cooling system for cooling the engine and gearbox. A typical cooling system circulates coolant to remove heat from the engine and the gearbox. Such coolant includes water and coolant additive. The cooling system includes a radiator. The coolant travels past the engine and the gearbox to carry heat away from them by heat exchange. Then, the coolant goes through the radiator where heat exchange takes place between the coolant and ambient air. Integrity of the cooling system is essential for normal and stable operation of the engine and the gearbox. After being constant turned between hot and cool statuses, the coolant eventually deteriorates and evaporates. Moreover, the coolant might corrode the radiator and piping of the cooling system. Hence, it is necessary to replace the used coolant with fresh coolant on a regular basis to ensure the efficiency and integrity of the cooling system.

The radiator includes an inlet in the top and an outlet in the bottom. A cap and a valve are used to close the inlet and the outlet selectively. To empty the radiator of the used coolant, traditionally, the valve is operated to open the outlet to allow the used coolant to fall in a bucket from the radiator via the outlet. However, the used coolant might wet the environment and wiring and parts of the vehicle during the fall.

Moreover, after the used coolant is drained from the radiator, fresh coolant must be filled in the radiator via the inlet. In the filling of the fresh coolant, air is often mixed in the fresh coolant. Such air causes troubles for a pump-motor combination used to circulate the coolant because air is compressible. Hence, the radiator, the engine and the gearbox might suddenly get too hot to operate normally. The engine and the gearbox might accordingly get damaged. In the worst scenario, the vehicle might be burned.

The present invention is therefore intended to obviate or at least alleviate the problems encountered in prior art.

### SUMMARY OF INVENTION

It is the primary objective of the present invention to provide an apparatus for replacing coolant in a vehicle via pressure difference.

To achieve the foregoing objective, the apparatus includes a communication unit, a pressure gauge, a flexible tube, a conical plug, a valve and a vacuum producer. The communication unit includes a first port, a second port and a third port in communication with one another. The pressure gauge is connected to the third port. The flexible tube is connected to the first port. The conical plug includes a liquid channel extending throughout the conical plug. The liquid channel is connected to the flexible tube. The valve includes a switch and a pneumatic quick coupling device. The switch is connected to the second port to selectively allow or stop communication of the pneumatic quick coupling device with the second port. The vacuum producer includes a pump and a hollow insert extending from the pump. The hollow insert is adapted for connection to the pneumatic quick coupling device so that the pump is operable to produce vacuum in the valve.

In an alternative aspect, the apparatus includes a communication unit, a pressure gauge, a flexible tube, a conical plug, a valve and a liquid conduction unit. The communication unit includes a first port, a second port and a third port in communication with one another. The pressure gauge is connected to the third port. The flexible tube is connected to the first port. The conical plug includes a liquid channel extending throughout the conical plug. The liquid channel is connected to the flexible tube. The valve includes a switch and a pneumatic quick coupling device. The switch is connected to the second port to selectively allow or stop communication of the pneumatic quick coupling device with the second port. The liquid conduction unit includes a hollow insert adapted for connection to the pneumatic quick coupling device and a flexible tube in communication with the hollow insert.

The apparatus in each of the foregoing aspect is operable to remove used coolant from a radiator without contaminating the environment that would otherwise occur with direct draining.

The apparatus in each of the foregoing aspect is operable to fill fresh coolant in a radiator without mixing air with the fresh coolant or contaminating the environment.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of an apparatus for replacing coolant for a vehicle according to the preferred embodiment of the present invention;

FIG. 2 is a partial and exploded view of the apparatus for replacing coolant for a vehicle shown in FIG. 1;

FIG. 3 is a perspective view of a communication unit of the apparatus for replacing coolant for a vehicle shown in FIG. 1;

FIG. 4 is a cross-sectional view of the communication unit and a pressure gauge of the apparatus for replacing coolant for a vehicle shown in FIG. 1;

FIG. 5 is a perspective view of the apparatus for replacing coolant for a vehicle shown in FIG. 1;

FIG. 6 is a partial and side view of the apparatus for replacing coolant for a vehicle shown in FIG. 1;

FIG. 7 is a partial and perspective view of the apparatus for replacing coolant for a vehicle shown in FIG. 1; and

FIG. 8 is a cross-sectional view of the apparatus for replacing coolant for a vehicle in another position than shown in FIG. 6.

### DETAILED DESCRIPTION OF PREFERRED EMBODIMENT

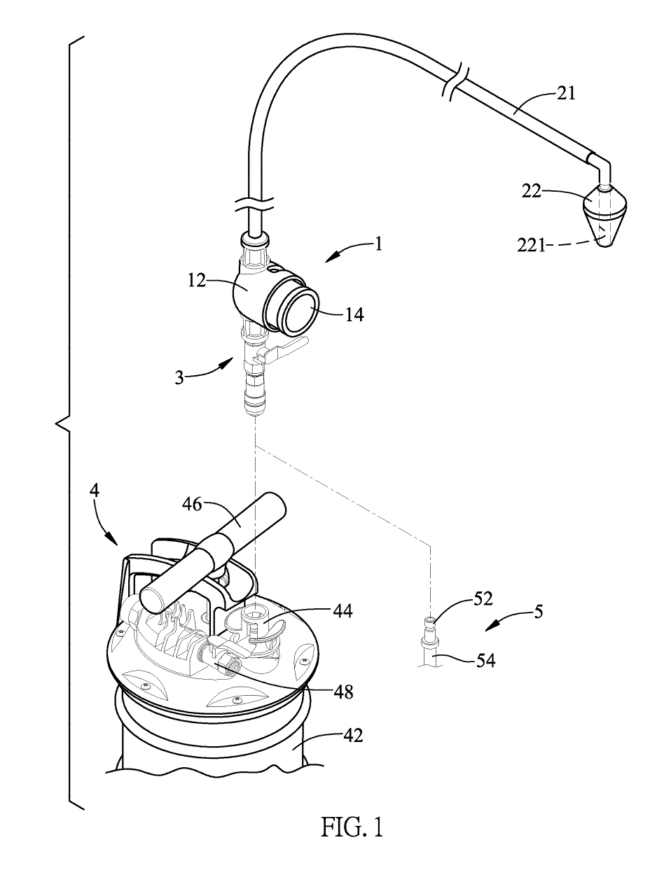

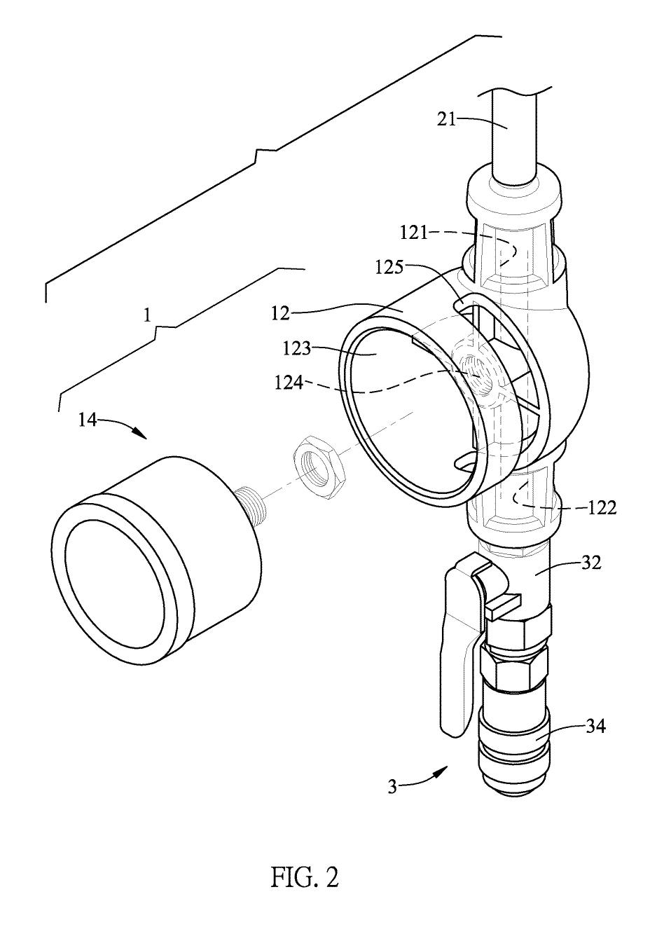

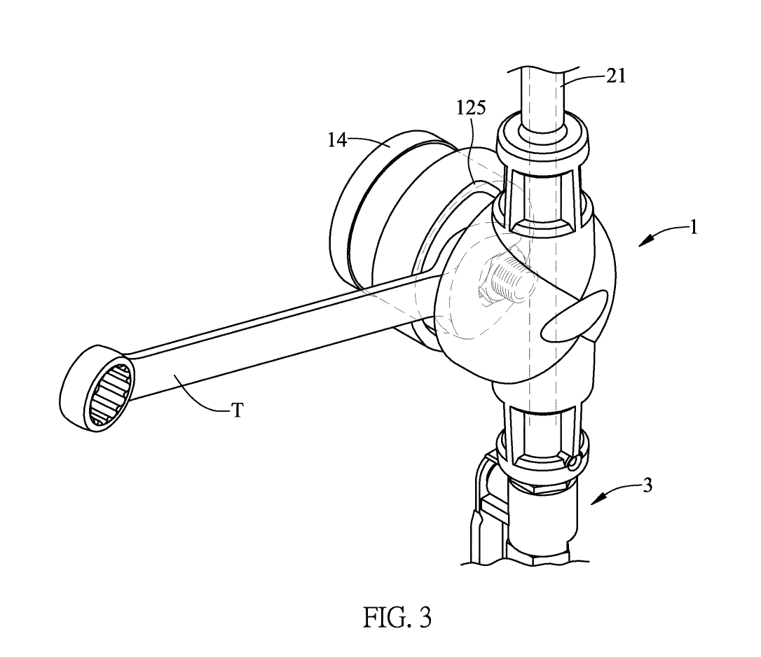

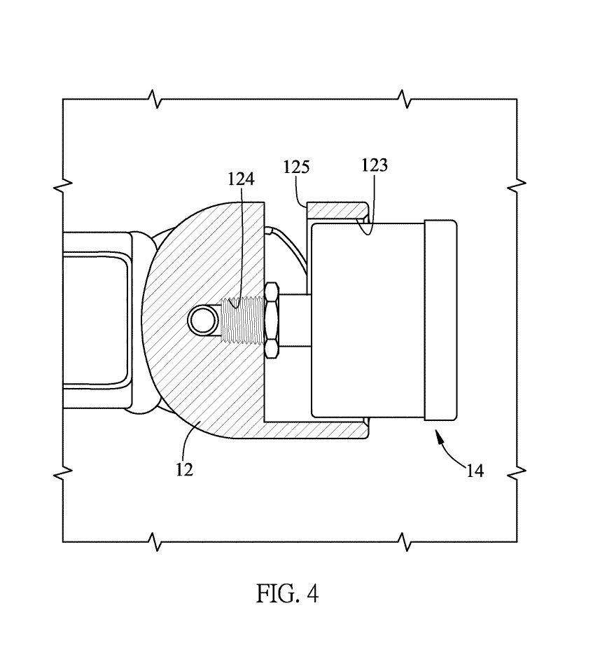

Referring to FIGS. 1 to 8, an apparatus for replacing coolant for a vehicle includes a communication unit 1, a pressure gauge 14, a flexible tube 21, a conical plug 22, a valve 3, a vacuum producer 4, and a liquid conduction unit 5 according to the preferred embodiment of the present invention. The flexible tube 21 is connected to the conical plug 22 at an end and connected to the communication unit 1 at another end. The valve 3 is connected to a lower end of the communication unit 1 and selectively connected to the vacuum producer 4 or the liquid conduction unit 5. The conical plug 22 is plugged in an inlet 62 of a radiator 6 before the vacuum producer 4 is used to suck used coolant from the radiator 6 or the liquid conduction unit 5 is used to fill fresh coolant in the radiator 6.

Referring to FIGS. 1 to 4, the communication unit 1 is in the form of a three-way manifold that includes a shell, a chamber 123, a slot 125 and three ports 121, 122 and 124. The shell includes a periphery 12 extending around a disc (not numbered). The periphery 12 and the disc are made in one piece. The periphery 12 is designed to provide the communication unit 1 with a desired profile, facilitate handling of the communication unit 1, and protect the pressure gauge 14. The shell defines the chamber 123. The slot 125 is made in the periphery 12. The ports 121, 122 and 124 are in communication with the chamber 123. The first port 121 is made on a side of the periphery 12. The second port 122 is made on another side of the periphery 12. The third port 124 is made in the disc.

The pressure gauge 14 is inserted in the chamber 123. The pressure gauge 14 is accessible by a tool T via the slot 125 of the communication unit 1. The tool T is used to fasten the pressure gauge 14 to the third port 124 of the communication unit 1.

The conical plug 22 includes a liquid channel 221. The liquid channel 221 extends throughout the conical plug 22, from the top to the bottom. The flexible tube 21 includes an end connected to an upper end of the liquid channel 221 and another end connected to the first port 121 of the communication unit 1.

The valve 3 includes a switch 32 and a pneumatic quick coupling device 34. The switch 32 is coaxially connected to the pneumatic quick coupling device 34. The switch 32 is connected to the second port 122 of the communication unit 1 via engagement of threads. The switch 32 is operable to control communication of the pneumatic quick coupling device 34 with the second port 122.

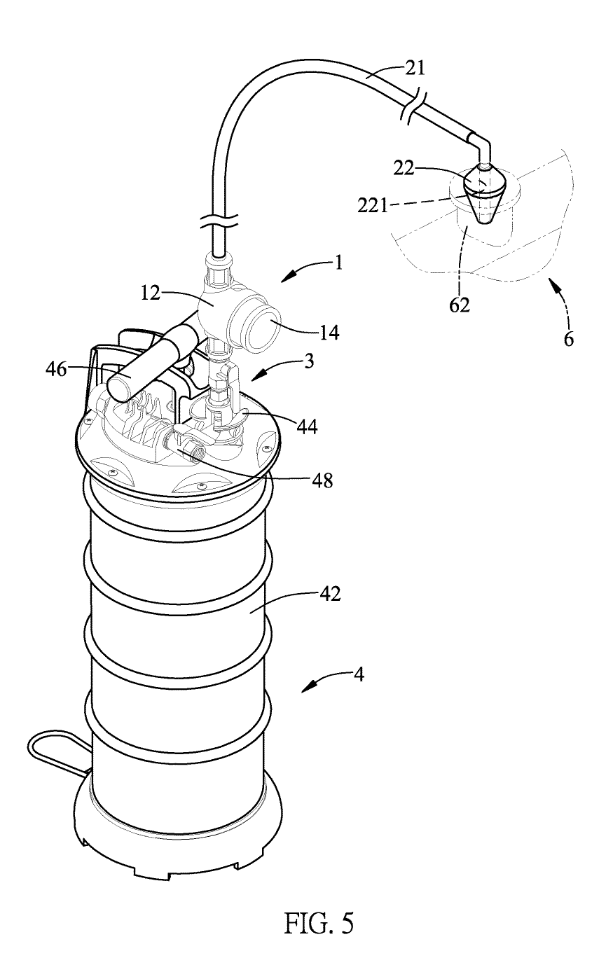

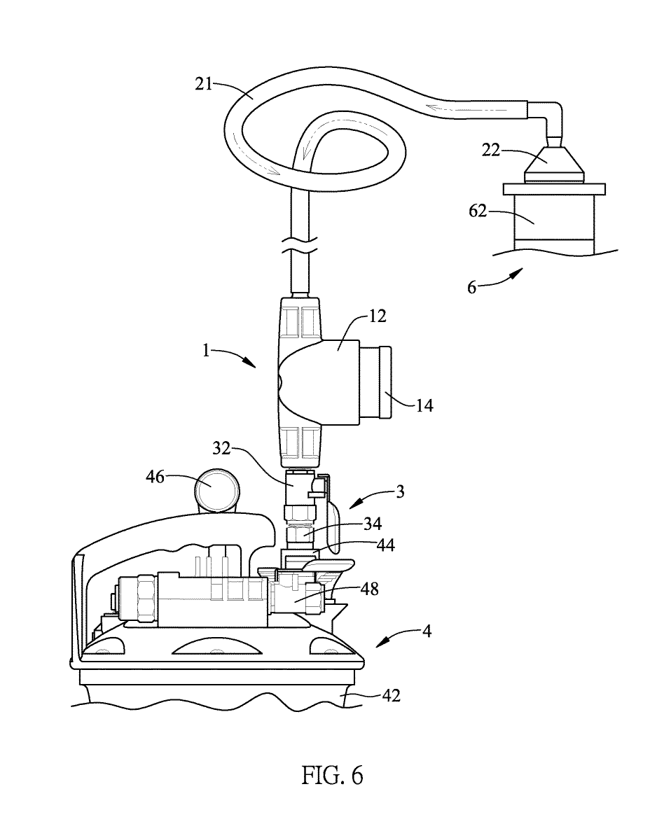

Referring to FIGS. 5 and 6, the vacuum producer 4 includes a hollow insert 44, a handle 46 and an air-pressure joint 48. The hollow insert 44, the handle 46 and the air-pressure joint 48 are provided at an upper end of a pump 42. Selectively, the hollow insert 44 is connected to the pneumatic quick coupling device 34 of the valve 3 or the air-pressure joint 48. With the hollow insert 44 connected to the pneumatic quick coupling device 34 of the valve 3, the handle 46 is operated to provide pressured air to cause the pump 42 to produce vacuum in the valve 3. With the hollow insert 44 connected to the air-pressure joint 48, the air-pressure joint 48 is further connected to a pressured air source to cause the pump 42 to produce vacuum in the valve 3.

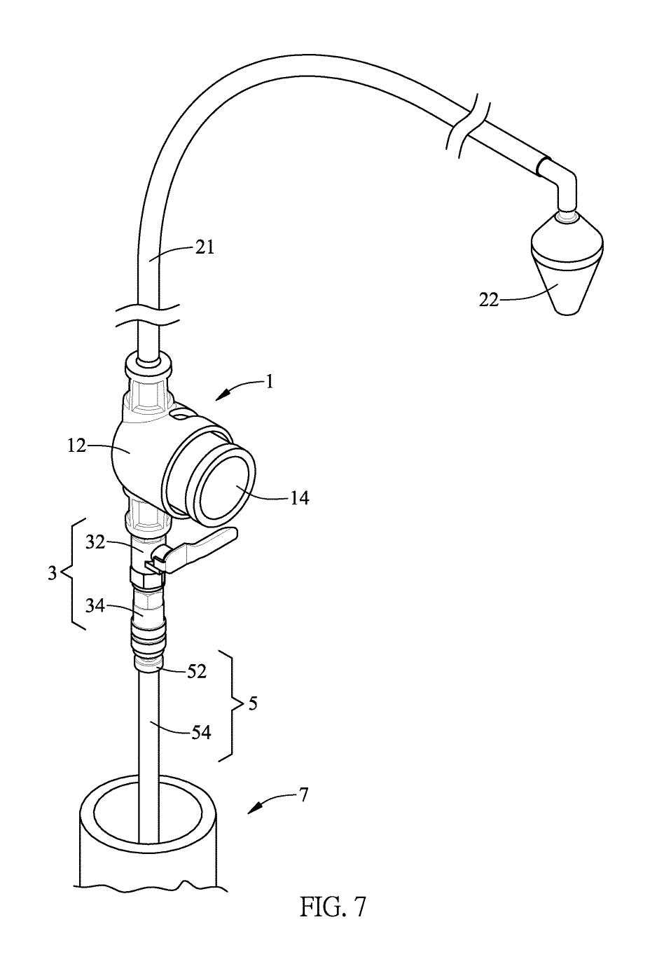

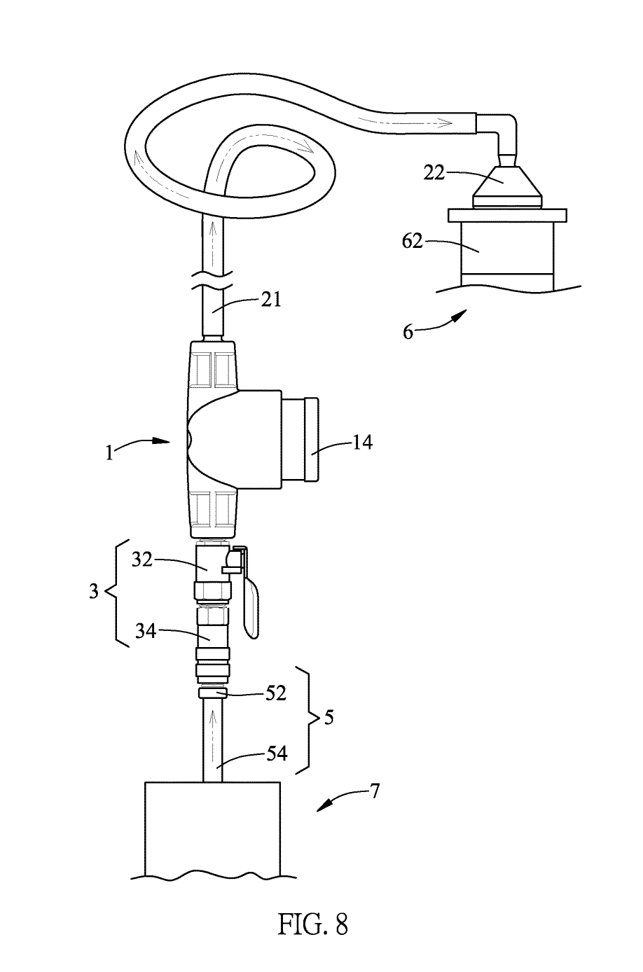

Referring to FIGS. 7 and 8, the liquid conduction unit 5 includes a hollow insert 52 and a flexible tube 54. An end of the flexible tube 54 is connected to the hollow insert 52. Selectively, the hollow insert 52 is connected to the pneumatic quick coupling device 34 of the valve 3 while another end of the flexible tube 54 is inserted in a reservoir 7 so that coolant can be pumped out of the reservoir 7.

As described above, the apparatus for replacing coolant according to the preferred embodiment is made. The operation of the apparatus the apparatus for replacing coolant is to be described.

Referring to FIGS. 5 and 6, the apparatus for replacing coolant is operated to empty the radiator 6 of used coolant. The pneumatic quick coupling device 34 of the valve 3 is connected to the hollow insert 44 of the vacuum producer 4. The conical plug 22 is plugged in the inlet 62 of the radiator 6. The vacuum producer 4 is used to suck the used coolant out of the radiator 6 sequentially through the valve 3, the communication unit 1, the flexible tube 21 and the conical plug 22. The coolant is filled in the vacuum producer 4 sequentially through the conical plug 22, the flexible tube 21, the communication unit 1 and the valve 3. Thus, vacuum is produced in the radiator 6. With the sucking, the used coolant is removed from the radiator 6 without contaminating the environment that would otherwise occur with direct draining.

Referring to FIGS. 7 and 8, the apparatus for replacing coolant is operated to fill the radiator 6 with fresh coolant. The switch 32 is operated to close the valve 3 to make sure that the communication unit 1, the flexible tube 21, the conical plug 22 and the radiator 6 are in a closed status. Then, the hollow insert 44 of the vacuum producer 4 is separated from the valve 3. Alternatively, the hollow insert 52 of the liquid conduction unit 5 is connected to the pneumatic quick coupling device 34 of the valve 3. Another end of the flexible tube 54 is inserted in the reservoir 7 in which the fresh coolant is stored. The end of the flexible tube 54 must be located below the level of the fresh coolant in the reservoir 7.

Then, the switch 32 is operated to open the valve 3 to communicate the flexible tube 54, the valve 3, the communication unit 1, the flexible tube 21, the conical plug 22 and the radiator 6 with one another. There is a sucking force in the radiator 6 due to vacuum in the radiator 6. The fresh coolant enters the radiator 6 substantially through the end of the flexible tube 54 submerged in the fresh coolant, the flexible tube 54, the valve 3, the communication unit 1, the flexible tube 21 and the conical plug 22. No air is mixed with the fresh coolant, and the environment is not contaminated by the fresh coolant. The conical plug 22 is detached from the inlet 62 of the radiator 6 after the radiator 6 is filled with a proper amount of the fresh coolant. Now, the replacement of the used coolant with the fresh coolant is completed.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for replacing coolant comprising:
a communication unit comprising a first port, a second port and a third port in communication with one another;
a pressure gauge connected to the third port;
a flexible tube connected to the first port;
a conical plug comprising a liquid channel extending throughout the conical plug, wherein the liquid channel is connected to the flexible tube;
a valve comprising a switch and a pneumatic quick coupling device, wherein the switch is connected to the second port to selectively allow or stop communication of the pneumatic quick coupling device with the second port; and
a vacuum producer comprising a pump and a hollow insert extending from the pump, wherein the hollow insert is adapted for connection to the pneumatic quick coupling device so that the pump is operable to produce vacuum in the valve.

2. The apparatus for replacing coolant according to claim 1, wherein the communication unit further comprises a chamber for containing the pressure gauge and a periphery extending around the chamber.

3. The apparatus for replacing coolant according to claim 2, wherein the communication unit further comprises a slot in communication with the chamber, wherein the slot is made in the periphery.

4. The apparatus for replacing coolant according to claim 3, wherein the pump further comprises a handle operable to drive the pump to produce vacuum.

5. The apparatus for replacing coolant according to claim 3, wherein the pump further comprises an air-pressure joint adapted for connection to a pressurized air source to drive the pump to produce vacuum.

6. An apparatus for replacing coolant comprising:
a communication unit comprising a first port, a second port and a third port in communication with one another;
a pressure gauge connected to the third port;
a flexible tube connected to the first port;
a conical plug comprising a liquid channel extending throughout the conical plug, wherein the liquid channel is connected to the flexible tube;
a valve comprising a switch and a pneumatic quick coupling device, wherein the switch is connected to the second port to selectively allow or stop communication of the pneumatic quick coupling device with the second port; and
a liquid conduction unit comprising a hollow insert adapted for connection to the pneumatic quick coupling device and a flexible tube in communication with the hollow insert.

7. The apparatus for replacing coolant according to claim 6, wherein the communication unit further comprises a chamber for containing the pressure gauge and a periphery extending around the chamber.

8. The apparatus for replacing coolant according to claim 7, wherein the communication unit further comprises a slot in communication with the chamber, wherein the slot is made in the periphery.

9. The apparatus for replacing coolant according to claim 8, wherein the pump further comprises a handle operable to drive the pump to produce vacuum.

10. The apparatus for replacing coolant according to claim 8, wherein the pump further comprises an air-pressure joint adapted for connection to a pressurized air source to drive the pump to produce vacuum.
